(19) United States
(12) Patent Application Publication
(10) Pub. No.: US 2025/0104919 A1
(43) Pub. Date: Mar. 27, 2025

(54) MULTILAYER CERAMIC CAPACITOR

(71) Applicant: AMOTECH CO., LTD., Incheon (KR)

(72) Inventors: Byungguk LIM, Incheon (KR); Jaeyong SONG, Incheon (KR); Yunsuk CHOI, Incheon (KR)

(73) Assignee: AMOTECH CO., LTD., Incheon (KR)

(21) Appl. No.: 18/725,761

(22) PCT Filed: Dec. 8, 2022
(86) PCT No.: PCT/KR2022/019911

§ 371 Date: Jun. 29, 2024

(30) Foreign Application Priority Data
Dec. 29, 2021 (KR) 10-2021-0190663
Dec. 30, 2021 (KR) 10-2021-0191919

(51) Int. Cl. H01G 4/232; H01G 4/30

(52) U.S. Cl. CPC H01G 4/232; H01G 4/30

(57) ABSTRACT

A multilayer ceramic capacitor according to the present invention may comprise: a ceramic body comprising a plurality of dielectric layers stacked together; a lower electrode formed at the lower surface of the ceramic body; and an electrode pillar formed from the lower surface of the ceramic body toward the inner center of the ceramic body, wherein the electrode pillar comprises a first electrode pillar formed at one side of the lower surface of the ceramic body and a second electrode pillar formed at the other side of the lower surface of the ceramic body, and the first electrode pillar and the second electrode pillar form an electrode.

### TECHNICAL FIELD

The present disclosure relates to a multilayer ceramic capacitor, and more particularly, to a multilayer ceramic capacitor, which has a precise low-capacity value and a reinforced joining force between a lower electrode and a dielectric.

### BACKGROUND ART

Recently, with the development of IT technology, the demand for multilayer ceramic capacitors (MLCC) is increasing significantly.

A multilayer ceramic capacitor is a component which makes a semiconductor operate smoothly by storing electricity and by stably supplying the electricity as much as an active component, such as the semiconductor, needs. Since the multilayer ceramic capacitor prevents the component, such as the semiconductor, from being broken by constantly supplying current, it is mounted on most products provided with electronic circuits.

Although the multilayer ceramic capacitor has the smallest size among electronic components, 500 to 700 layers of dielectrics and electrodes overlap one another in the multilayer ceramic capacitor, and the more the dielectrics are stacked, the more electricity can be stored. Accordingly, stacking of a lot of dielectrics in a small space is the core technology in a method for manufacturing the multilayer ceramic capacitor.

Meanwhile, the multilayer ceramic capacitor is composed of dielectrics, inner electrodes, and outer electrodes, and electric charge is accumulated between the inner electrodes facing each other. However, in case of high frequencies requiring a quick response, a low-capacity multilayer ceramic capacitor having a small number of stacks of inner electrodes or having no inner electrode is used.

In this case, if the number of stacks of inner electrodes is small, a tensile strength is weak, and thus cracks may easily occur in a soldering process. If the cracks occur in the multilayer ceramic capacitor that requires a high level of durability, there is a problem in that the performance of the multilayer ceramic capacitor is decreased.

Further, the multilayer ceramic capacitor in the related art may not be provided with inner electrodes therein in order to be produced with a low capacity that is equal to or lower than 100 nF. However, in case of the low-capacity ceramic capacitor that is not provided with the inner electrodes, it is necessary that its capacitance value should be particularly precise, but the low-capacity ceramic capacitor in the related art has a problem in that it is difficult to satisfy such a precise capacitance value.

Meanwhile, the multilayer ceramic capacitor requires the high level of durability, should particularly endure the high temperature and high voltage, and involves microstructure design technology, such as reinforcement of the vibration characteristics.

In case of the multilayer ceramic capacitor in the related art, a structure, in which the equivalent series inductance is reduced and a mounting space can be saved, is disclosed, but there is a problem in that solutions to reinforce the joining force between a circuit board and the multilayer ceramic capacitor are not mentioned, and any solving technology capable of preventing cracks of the ceramic body in the manufacturing process is not mentioned.

The matters described in the above background technology are to help understanding of the background of the present disclosure, and may include the matters that are not the disclosed related art.

### SUMMARY OF INVENTION

### Technical Problem

A technical matter to be solved by the present disclosure is to provide a small and precise multilayer ceramic capacitor having a low capacitance and a low capacitance error.

Another technical matter to be solved by the present disclosure is to provide a multilayer ceramic capacitor, which can prevent a structural strength of an external electrode from being weakened since the external electrode becomes weak in structure and strength in case of being formed through penetration of a hole thereon.

Another technical matter to be solved by the present disclosure is to provide a multilayer ceramic capacitor having a reinforced joining force between a dielectric and an external electrode (lower electrode).

Another technical matter to be solved by the present disclosure is to provide a multilayer ceramic capacitor, which can prevent cracks from occurring through reinforcing of durability.

Other technical matters to be solved by the present disclosure are not limited to the above-mentioned matters, and other unmentioned matters will be able to be clearly understood by those of ordinary skill in the art from the following description.

### Solution to Problem

In order to solve the above technical matters, a multilayer ceramic capacitor according to the present disclosure includes: a ceramic body in which a plurality of dielectric layers are stacked; a lower electrode formed on a lower surface of the ceramic body; and a hollow groove formed to be depressed from the lower surface of the ceramic body toward an inside of the ceramic body.

The multilayer ceramic capacitor may further include an electrode pole formed in the hollow groove, wherein the electrode pole may include: a first electrode pole formed on one side of the lower surface of the ceramic body; and a second electrode pole formed on the other side of the lower surface of the ceramic body, and wherein the first electrode pole and the second electrode pole may form an electrode.

The lower electrode may include a first lower electrode and a second lower electrode formed on both sides of the lower surface of the ceramic body, and the first electrode pole and the second electrode pole may be formed to face each other at a location symmetrical to the lower surface of the ceramic body.

The electrode pole may be formed so that a length direction thereof is in parallel to a height direction of the ceramic body, and a diameter of a cross section that is vertical to the length direction of the electrode pole may be reduced toward an inner center of the ceramic body.

A plurality of first electrode poles may be disposed along a length direction of the first lower electrode, and a plurality of second electrode poles may be disposed along a length direction of the second lower electrode, and the second electrode poles may maintain the same interval as the interval of the first electrode poles, respectively.

The electrode pole may be provided with a metal layer on a surface thereof.

The electrode pole may be formed with a length that is equal to or smaller than a half of a height of the ceramic body.

The multilayer ceramic capacitor may include a plurality of inner electrodes disposed to face each other inside the ceramic body, the lower electrode may include a through-hole formed to penetrate the lower electrode in a height direction, and the ceramic body may include a hollow groove formed inside the ceramic body to communicate with the through-hole.

The lower electrode may include a first lower electrode and a second lower electrode formed on both sides of the lower surface of the ceramic body, and the through-hole may include: a first through-hole formed on the first lower electrode; and a second through-hole formed on the second lower electrode, and the hollow groove may include:

a first hollow groove formed to correspond to the first through-hole; and a second hollow groove formed to correspond to the second through-hole, and the first hollow groove and the second hollow groove may have different lengths.

The inner electrode may include: a first inner electrode connected to the first hollow groove; and a second inner electrode connected to the second hollow groove, and the first inner electrode may be disposed to be biased toward one side surface of an inside of the ceramic body, and the second inner electrode may be disposed to be biased toward the other side surface of the inside of the ceramic body.

The first inner electrode and the second inner electrode may form an overlap area.

The through-hole may be formed with a diameter that is equal to or larger than two-thirds of a thickness of the lower electrode and equal to or smaller than a thickness of the lower electrode.

The hollow groove may be formed with a diameter that is equal to or larger than two-thirds of a thickness of the lower electrode and equal to or smaller than a thickness of the lower electrode.

A plurality of through-holes may be disposed at predetermined intervals along a length direction of the lower electrode, and a plurality of hollow grooves may be disposed to communicate with the through-holes.

The hollow groove may be formed with a length that is equal to or larger than one-fifth and equal to or smaller than one-third of a height of the ceramic body.

A first metal layer may be formed on an inner surface of the through-hole, and a second metal layer may be formed on an inner surface of the hollow groove.

The lower electrode may include a joining hole formed to penetrate the lower electrode in a height direction and not to overlap the through-hole, and the ceramic body may include a joining groove formed to be depressed on the lower surface of the ceramic body, to correspond to an outer periphery of the joining hole, and not to overlap the hollow groove.

The ceramic body may include a discharge port formed to penetrate a side surface of the ceramic body and the hollow groove.

The ceramic body may include a via disposed to be spaced apart from the hollow groove on the lower surface of the ceramic body and electrically connected to the lower electrode, and the via may include: a first via electrically connected to a first lower electrode; and a second via electrically connected to a second lower electrode.

### Advantageous Effects of Invention

According to the present disclosure, the following effects can be produced.

First, since the electrode pole is formed on the lower surface of the ceramic body by using a laser after the ceramic body is sintered, the electrode pole can be formed at an exact location intended by the user without an error. Accordingly, the interval between the first electrode pole and the second electrode pole can be kept constant, and thus the plurality of electrode poles can be formed with the capacitance kept constant without an error. Accordingly, an accurate capacitance value can be provided.

Further, since the electrode pole is formed by the laser after the ceramic body is sintered, the length of the electrode pole can be kept accurately. Accordingly, the capacitance formed by the first electrode and the second electrode can be kept constant without an error.

Further, since the electrode pole can be formed with a depth that is equal to or smaller than a half of the height of the ceramic body, the through-hole is not formed on the ceramic body, and thus the strength of the capacitor according to the present disclosure is not weakened. Further, as compared with the case where the via is penetratingly formed, the current path is relatively short to lower the ESL, and thus the function of the capacitor can be improved.

Further, since the diameter of the cross section that is vertical to the length direction of the electrode pole decreases toward the center of the ceramic body, the cracks can be prevented from occurring on the inner surface of the ceramic body. Accordingly, the structural stability of the present disclosure can be maintained.

Further, the electrode pole is electrically connected to the lower electrode directly. Accordingly, the equivalent series resistance is formed small as compared with the case where the resistor is not directly connected, and thus heat generation is reduced, thereby improving durability.

Further, according to the present disclosure, the via is formed by filling the through-hole and the hollow groove through a soldering process. Due to this, the lower electrode disposed between the solder and the ceramic body is fixed, the joining force between the lower electrode and the ceramic body can be reinforced simultaneously with the electrical connection thereof.

Further, according to the present disclosure, a joining hole and a joining groove are separately provided. The joining hole and the joining groove are separately provided without overlapping the through-hole and the hollow groove, respectively. Due to this, the solder is filled in the joining hole and the joining groove through the soldering process, and thus the joining force between the lower electrode and the ceramic body can be further reinforced.

Further, the hollow groove is formed with a depression length that is equal to or larger than one-fifth and equal to or smaller than one-third of the height of the ceramic body. Due to this, fractures, such as cracks, can be prevented from occurring on the ceramic body, and thus the durability of the present disclosure can be reinforced. Further, if the depression length of the hollow groove is limited as described above, the via is formed with a short length. Accordingly, the equivalent series resistance is formed small through shortening of the current path, and thus the function of the capacitor can be improved.

Effects of the present disclosure are not limited to the above-mentioned effects, and other unmentioned effects will be clearly understood by those of ordinary skill in the art from the following description.

### BRIEF DESCRIPTION OF DRAWINGS

FIG. 1 is a perspective view illustrating a multilayer ceramic capacitor according to an embodiment of the present disclosure.

FIG. 2 is a cross-section view taken along line A-A′ of FIG. 1.

FIG. 3 is a bottom view of FIG. 1.

FIG. 4 is a bottom view illustrating another embodiment of FIG. 3.

FIG. 5 is a conceptual view explaining forming of capacitance C between a first electrode pole and a second electrode pole.

FIG. 6 is a cross-sectional view taken along line B-B′ of FIG. 4.

FIG. 7A is a cross-sectional view illustrating a state where cracks occur inside a ceramic body adjacent to an end part of an electrode pole.

FIG. 7B is a cross-sectional view illustrating another embodiment of FIG. 6.

FIG. 8 is a cross-sectional view illustrating another embodiment of FIG. 2.

FIG. 9 is a flowchart illustrating a method for manufacturing a multilayer ceramic capacitor according to an embodiment of the present disclosure.

FIG. 10 is a perspective view of a multilayer ceramic capacitor according to another embodiment of the present disclosure.

FIG. 11 is a cross-section view taken along line A-A′ of FIG. 10.

FIG. 12 is a bottom view of FIG. 10.

FIG. 13 is a cross-sectional view of an embodiment in which an inner electrode is added to FIG. 11.

FIG. 14 is a cross-sectional view when FIG. 13 is viewed in the direction of B-B′ of FIG. 12.

FIG. 15 is a cross-sectional view of another embodiment in which a discharge port is added to FIG. 13.

FIG. 16 is a cross-sectional view of another embodiment in which a joining hole and a joining groove are added to FIG. 13.

FIG. 17 is a bottom view of FIG. 16.

FIG. 18 is a cross-sectional view of another embodiment of FIG. 13.

FIG. 19 is a bottom view of FIG. 18.

FIG. 20 is a flowchart illustrating a method for manufacturing a multilayer ceramic capacitor according to another embodiment of the present disclosure.

FIG. 21 is a perspective view illustrating a stacked state of a ceramic body in step S100′ of FIG. 20.

### DESCRIPTION OF EMBODIMENTS

The aspects and features of the present disclosure and methods for achieving the aspects and features will be apparent by referring to the embodiments to be described in detail with reference to the accompanying drawings. However, the present disclosure is not limited to the embodiments disclosed hereinafter, and it can be implemented in various different forms. However, the embodiments are provided to complete the present disclosure and to assist those of ordinary skill in the art in a comprehensive understanding of the scope of the technical idea, and the disclosure is only defined by the scope of the appended claims.

Terms used in the description are to explain specific embodiments, but are not intended to limit the present disclosure. Further, in the description, unless specially described on the contrary in context, a singular form may include a plural form.

In the description, the term “comprises” and/or “comprising” should be interpreted as not excluding the presence or addition of one or more other constituent elements in addition to the mentioned constituent elements.

The term “and/or” used in the description includes each of the mentioned constituent elements and all combinations of one or more thereof. Although the terms “first”, “second”, and so forth are used to describe various constituent elements, these constituent elements should not be limited by the terms. The above-described terms are used only for the purpose of discriminating one constituent element from another constituent element. Accordingly, a first constituent element to be mentioned hereinafter may be a second constituent element in the technical idea of the present disclosure.

The term “horizontal direction” used in the following description means a forward, rearward, left, or right direction in a state where a location in an upward or downward direction is not changed, and the term “vertical direction” used in the following description means an upward or downward direction in a state where a location in a forward, rearward, left, or right direction is not changed.

In describing the embodiments, in case that each layer (film), area, pattern, or structure is described to be formed “on” or “under” each substrate, layer (film), area, pad, or pattern, the terms “on” and “under” include both “direct” and “indirect” forming. Further, the criterion of “on” or “under” each layer is principally based on the drawings.

The drawings are merely to understand the idea of the present disclosure, and it should not be interpreted that the scope of the present disclosure is limited by the drawings. Further, in the drawings, relative thicknesses, lengths, or sizes may be exaggerated for convenience and clarity of the description, and throughout the description, the same reference numerals refer to the same constituent elements.

Hereinafter, embodiments of the present disclosure will be described in detail with reference to the accompanying drawings.

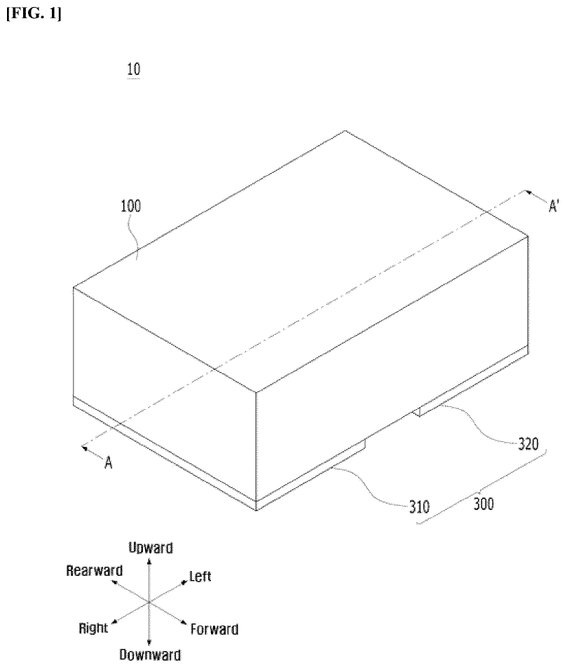

FIG. 1 is a perspective view illustrating a multilayer ceramic capacitor 10 according to an embodiment of the present disclosure.

Referring to FIG. 1, a multilayer ceramic capacitor 10 includes a ceramic body 100 and a lower electrode 300.

The ceramic body 100 is constituted by stacking a plurality of dielectric layers. The dielectric layer includes a material capable of obtaining capacitance. For example, the dielectric material may include a ceramic powder, ceramic additives, and the like. The dielectric layer may also be composed of a ceramic green sheet, and the thickness of the dielectric layer may be arbitrarily changed to fit to capacity design according to an embodiment of the present disclosure.

There are no particular restrictions on the shape of the ceramic body 100, but, as illustrated, the ceramic body 100 may be formed in a hexahedron shape. Although corners of the ceramic body 100 are not perfectly straight due to high temperature and the like in a manufacturing process, the ceramic body 100 may have substantially the hexahedron shape.

The lower electrode 300 is formed on a lower surface of the ceramic body 100. There are no particular restrictions on the material that forms the lower electrode 300, and the lower electrode 300 may be formed by using a conductive material including, for example, silver, copper, lead, platinum, and nickel.

Further, although not illustrated, the lower electrode 300 may be formed in a three-layer structure of copper, silver-epoxy, and nickel. Tin may be used instead of nickel. In this case, the silver-epoxy may absorb an external force that is applied to the lower electrode 300, and may prevent cracks from occurring on the ceramic body 100.

The lower electrode 300 includes a first lower electrode 310 and a second lower electrode 320 formed on both sides of the lower surface of the ceramic body 100. The first lower electrode 310 and the second lower electrode 320 may be formed by printing or applying the lower electrode material on both sides of the lower surface of the ceramic body 100.

In this case, capacitance may be formed between the first lower electrode 310 and the second lower electrode 320. The details thereof will be described later.

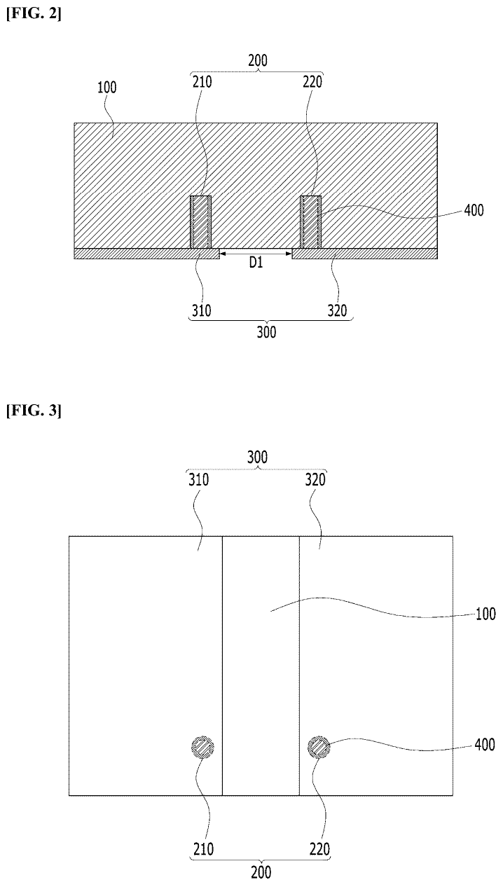

FIG. 2 is a cross-section view taken along line A-A′ of FIG. 1, and FIG. 3 is a bottom view of FIG. 1.

Referring to FIGS. 2 and 3, the multilayer ceramic capacitor 10 includes an electrode pole 200.

The electrode pole 200 is formed from the lower surface of the ceramic body 100 toward the center of the ceramic body 100. Specifically, the electrode pole 200 is formed so that a length direction of the electrode pole 200 is in parallel to a height direction of the ceramic body 100. This means that the electrode pole 200 is disposed so that a cross section that is vertical to a center axis in the length direction of the electrode pole 200 is vertical to the height direction of the ceramic body 100. In this case, the length direction of the electrode pole 200 is defined as an upward or downward direction of a coordinate system illustrated in FIG. 1, and the height direction of the ceramic body 100 is also defined as the upward or downward direction of the coordinate system illustrated in FIG. 1.

The electrode pole 200 may be formed by forming a hollow groove (not illustrated) through radiation of laser or the like on the lower surface of the ceramic body 100, and by filling the formed hollow groove with a metal. In this case, a metal layer (not illustrated) may be formed on an inner surface of the hollow groove so that the metal that is filled in the hollow groove can be filled into the internal end of the hollow groove. The metal layer may be formed by sputtering the inner surface of the hollow groove.

If the metal layer is formed inside the hollow groove as described above, the melted metal can flow smoothly into the inside of the hollow groove due to the capillary phenomenon. In this case, the material that forms the metal layer may be the same as or may be different form the material of the electrode pole 200.

The electrode pole 200 may be in a hollow pipe shape, and the metal may be filled inside the pipe-shaped electrode pole 200. In this case, in order to easily fill the electrode pole 200 with the metal, a metal layer 400 may be formed on the inner surface of the electrode pole 200.

The electrode pole 200 includes a first electrode pole 210 and a second electrode pole 220. The first electrode pole 210 is formed on one side of the lower surface of the ceramic body 100, and the second electrode pole 220 is formed on the other side of the lower surface of the ceramic body 100.

That is, the first electrode pole 210 and the second electrode pole 220 are disposed to be spaced apart from each other so that their length directions (upward and downward direction) are parallel to each other. Due to this, an electrode may be formed between the first electrode pole 210 and the second electrode pole 220. Accordingly, capacitance may be formed between the first electrode pole 210 and the second electrode pole 220.

Meanwhile, as described above in relation to the capacitance, the capacitance may be formed between the first lower electrode 310 and the second lower electrode 320. In this case, the capacitance may be adjusted by adjusting an interval D1 between the first lower electrode 310 and the second lower electrode 320. In this case, the capacitance formed by the first lower electrode 310 and the second lower electrode 320 has a low capacity, and this is suitable to be used at high frequencies at which a quick response is required. The capacitance formed between the first electrode pole 210 and the second electrode pole 220 may also have the low capacity.

The first electrode pole 210 may be disposed adjacent to an end part of one side of the first lower electrode 310, and the second electrode pole 220 may be disposed adjacent to an end part of one side of the second lower electrode 320.

That is, since the first electrode pole 210 and the second electrode pole 220 are disposed at two facing end part locations of the first lower electrode 310 and the second lower electrode 320, the first electrode pole 210 and the second electrode pole 220 that face each other may be formed at a close interval. Accordingly, in this case, a relatively large amount of electric charge can be accumulated as compared with a case where two electrode poles are disposed at a long interval.

The electrode pole 200 is electrically connected to the lower electrode 300. In this case, since the electrode pole 200 is directly connected to the lower electrode 300, the equivalent series resistance is formed smaller as compared with the case where the resistor is not directly connected. If the equivalent series resistance is small, the heating value may be reduced, and thus the effect of improving durability (lifetime) is achieved in the embodiment.

For smooth electrical connection between the electrode pole 200 and the lower electrode 300, the metal layer 400 may be provided on an inner surface of the electrode pole 200. In this case, the metal layer 400 may be formed by depositing the metal on the inner surface of the electrode pole 200 through utilization of a deposition method, such as sputtering. If the metal layer 400 is formed on the inner surface of the electrode pole 200 as above, it may be easier to fill the electrode pole 200 with the metal.

In this case, the metal that forms the metal layer 400 may be different from the material of the metal that is filled in the electrode pole 200, but it does not necessarily have to be different, and may be the same material as the metal that forms the electrode pole 200.

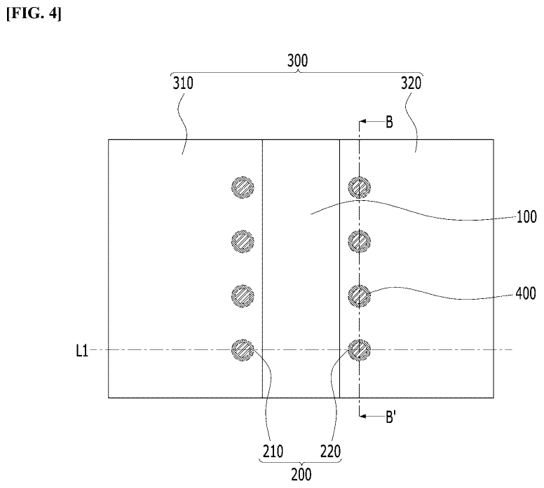

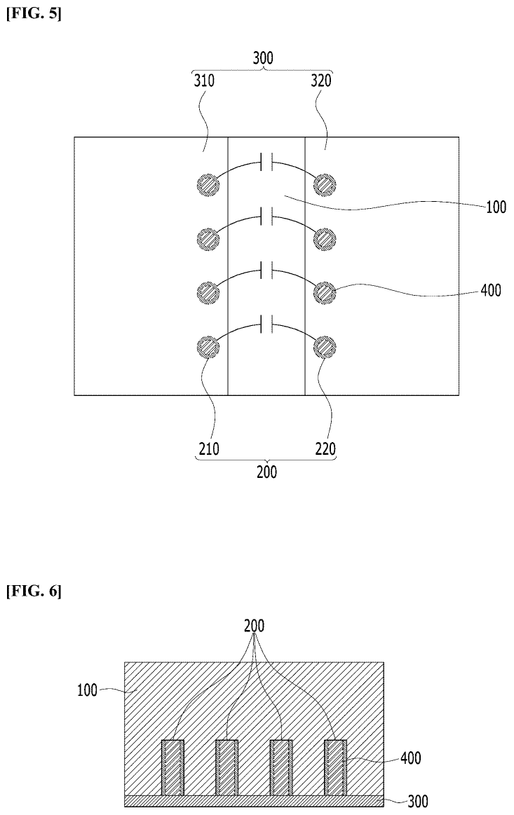

FIG. 4 is a bottom view illustrating another embodiment of FIG. 3, and FIG. 5 is a conceptual view explaining forming of capacitance between a first electrode pole 210 and a second electrode pole 220, and FIG. 6 is a cross-sectional view taken along line B-B′ of FIG. 4.

Referring to FIGS. 4 to 6, a plurality of first electrode poles 210 may be formed at predetermined intervals along a length direction (forward or rearward direction of a coordinate system illustrated in FIG. 1) of the ceramic body 100, on one side (right of the coordinate system illustrated in FIG. 1) of the lower surface of the ceramic body 100. The length direction may also be the length direction of the first lower electrode 310. In this case, the interval between the first electrode poles 210 may be changed depending on the capacitance required by a user.

A plurality of second electrode poles 220 may be formed along the length direction (forward or rearward direction of the coordinate system illustrated in FIG. 1) of the ceramic body 100, on the other side (left of the coordinate system illustrated in FIG. 1) of the lower surface of the ceramic body 100. The length direction may also be the length direction of the second lower electrode 320.

In this case, the first electrode poles 210 and the second electrode poles 220 are provided at corresponding locations, and this means that the first electrode poles 210 and the second electrode poles 220 are provided on a virtual line L1 that is in parallel to left and right corners of the ceramic body 100. The first electrode poles 210 and the second electrode poles 220 formed on the virtual line may form the above-described capacitances.

Meanwhile, the interval between the first electrode poles 210 of the plurality of first electrode poles 210 and the interval between the second electrode poles 220 of the plurality of second electrode poles 220 are set to be equal to each other. That is, since the corresponding first electrode poles 210 and second electrode poles 220 are produced at the same time, the same effect is achieved as if several capacitors are provided.

The electrode pole 200 may be formed with a length that is equal to or smaller than a half (½) of a height of the ceramic body 100. If the electrode pole 200 is formed in the form of a hole that penetrates the ceramic body 100, the ceramic body 100 may become structurally weak, and its strength may be decreased. Accordingly, by forming the electrode pole 200 with the length (height) that is equal to or smaller than a half of the height of the ceramic body 100, the structural stability of the ceramic body 100 can be maintained.

Further, in case that the electrode pole 200 is formed with the length that is equal to or smaller than a half of the height of the ceramic body 100, it is the same as forming a short current path as compared with a case where the electrode pole 200 is penetratingly formed in the height direction of the ceramic body 100, and this may decrease the equivalent series inductance (ESL), so that the function of the capacitor can be improved.

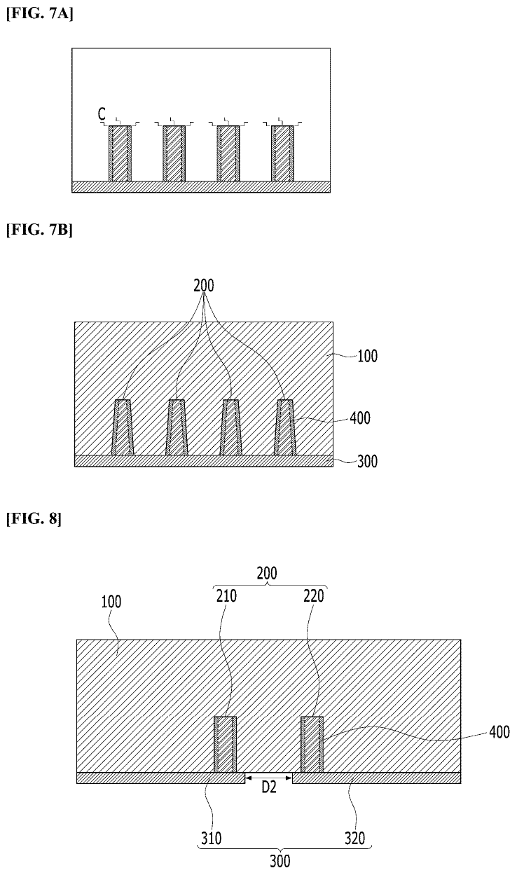

FIG. 7A is a cross-sectional view illustrating a state where cracks occur inside a ceramic body adjacent to an end part of an electrode pole 200, and FIG. 7B is a cross-sectional view illustrating another embodiment of FIG. 6.

Referring to FIGS. 7A and 7B, if a diameter of a cross section that is vertical to the length direction of the electrode pole 200 may be reduced toward a center of the ceramic body 100. That is, the electrode pole 200 may be provided in a tapered shape as in FIG. 7B.

If the diameter of the cross section that is vertical to the length direction of the electrode pole 200 is constant regardless of the length of the electrode pole 200, as illustrated in FIG. 7A, cracks C may occur inside the ceramic body 100 that is adjacent to an end part (closest part to the center of the ceramic body 100) of the electrode pole 200 in the process of forming the electrode pole 200 on the ceramic body 100.

Accordingly, as illustrated in FIG. 7B, if the electrode pole 200 is formed in a tapered shape in which the diameter of the cross section that is vertical to the length direction of the electrode pole 200 is gradually reduced toward the inner center of the ceramic body 100, it is possible to prevent the cracks from occurring inside the ceramic body 100 that comes in contact with the electrode pole 200, and thus the structural stability of the capacitor can be maintained.

FIG. 8 is a cross-sectional view illustrating another embodiment of FIG. 2.

Referring to FIG. 8, in the illustrated embodiment, the first lower electrode 310 is constituted so that the center of the cross section is closer to the center of the ceramic body 100 rather than on side surface (right) of the ceramic body 100, and the second lower electrode 320 is constituted so that the center of the cross section is closer to the center of the ceramic body 100 rather than the other side surface (left) of the ceramic body 100. That is, in the embodiment illustrated in FIG. 8, it is meant that the interval D2 between the first lower electrode 310 and the second lower electrode 320 is shorter than the interval D1 in the embodiment of FIG. 2.

Accordingly, an interval between via poles provided on the first electrode pole 210 and the second electrode pole 220 becomes shorter, and thus the capacitance can be improved.

That is, by adjusting the length between the first lower electrode 310 and the second lower electrode 320, the interval between the first electrode pole 210 and the second electrode pole 220, which are electrically connected to the lower electrodes 310 and 320, respectively, can be changed, and based on this, the intended capacitance can be stored.

FIG. 9 is a flowchart illustrating a method for manufacturing a multilayer ceramic capacitor 10 according to an embodiment of the present disclosure.

Referring to FIG. 9, a method for manufacturing a multilayer ceramic capacitor 10 includes: a step (S100) of manufacturing a ceramic body 100; an electrode pole 200 forming step (S200) of forming a first electrode pole 210 and a second electrode pole 220 disposed from a lower surface of the ceramic body 100 toward an inner center of the ceramic body 100; and a step (S300) of forming a lower electrode 300 on the lower surface of the ceramic body 100.

In the step (S100) of manufacturing the ceramic body, the ceramic body 100 can be formed by stacking a plurality of dielectrics, compressing the stacked dielectrics by heat, and then sintering the compressed dielectrics. The ceramic body 100 may be formed without disposing an inner electrode inside the ceramic body 100.

In the step (S200) of forming the electrode pole, a hollow groove may be formed by radiating a laser onto the lower surface of the ceramic body 100, and the electrode pole 200 may be formed by filling the hollow groove with a metal.

The first electrode pole 210 and the second electrode pole 220 may be formed by radiating the laser at predetermined intervals on both sides of the lower surface of the ceramic body 100.

In particular, since the laser is radiated after the ceramic body 100 is sintered, the first electrode pole 210 and the second electrode pole 200 can be formed at exactly intended locations even if being formed at narrow intervals, and cracks may not occur on the ceramic body 100 as well.

Since the locations where the first electrode pole 210 and the second electrode pole 200 are formed, the lengths, the number, and the effects thereof are the same as those of the multilayer ceramic capacitor 10 corresponding to the above-described embodiment, detailed explanation thereof will be omitted.

In this case, the electrode poles 200 are formed by radiating the laser after the ceramic body 100 is made hard through sintering, and thus even if a plurality of electrode poles 200 are formed, the diameter and the length of each of the electrode poles 200 can be maintained constant, and the intervals between the electrode poles 200 can also be maintained constant. Due to this, an error between the capacitance of the capacitor and an expected value before a user produces the embodiments of the present disclosure can be reduced.

Meanwhile, in the step (S200) of forming the electrode pole, when the electrode pole 200 is formed by filling the metal in the hollow groove formed by radiating the laser on the lower surface of the ceramic body 100, a metal layer (not illustrated) may be formed on the inner surface of the hollow groove in order to easily fill the metal therein.

Further, even in case of filling the electrode pole 200 with the metal, the metal layer 400 may be formed on the inner surface of the electrode pole 200 so that the metal can be easily filled. In this case, the material that forms the metal layer inside the hollow groove or the metal layer 400 inside the electrode pole 200 may be different from the metal that is filled in the hollow groove or the electrode pole 200, but it does not necessarily have to be different, and may be the same material as the metal that forms the electrode pole 200.

In addition, the metal layer that is formed on the inner surface of the hollow groove formed by radiating the laser or the metal layer that is formed on the inner surface of the electrode pole 200 may be formed by depositing the metal by utilizing a deposition method, such as sputtering. The sputtering is a kind of vapor deposition method, and means a method for making a film on a neighboring substrate by spurting atoms of purpose through generation of plasma in relatively low vacuum, acceleration of gases, such as ionized argon and the like, and crashing of the gases into a target.

If the metal layer is provided on the inner surface of the hollow groove or the inner surface of the electrode pole 200, it may be easy to fill the hollow groove or the electrode pole 200 with the metal. Due to this, in case of forming the electrode poles by filling each of the electrode poles 200 with the metal, the lengths of the electrode poles will be able to be maintained constant.

In the step (S300) of forming the lower electrode 300, the lower electrode 300 may be formed by applying or printing a conductive material on the lower surface of the ceramic body 100. In this case, the material that forms the lower electrode 300 is the same as described above.

Meanwhile, in the step (S300) of forming the lower electrode 300, the first lower electrode 310 and the second lower electrode 320 may be formed on both sides of the lower surface of the ceramic body 100.

In this case, the first lower electrode 310 may be formed so that the first electrode pole 210 is disposed adjacent to the end part of the first lower electrode 310, and the second lower electrode 320 may be formed so that the second electrode pole 220 is disposed adjacent to the end part of the second lower electrode 320.

Further, the first lower electrode 310 may be constituted so that the center of the cross section of the first lower electrode 310 is closer to the center of the ceramic body 100 rather than on side surface of the ceramic body 100. Further, the second lower electrode 320 may be constituted so that the center of the cross section of the second lower electrode 320 is closer to the center of the ceramic body 100 rather than the other side surface of the ceramic body 100. That is, in case that the first electrode pole 210 and the second electrode pole 220 are formed at narrow intervals, the first lower electrode 210 and the second lower electrode 320 may also be formed at narrow intervals.

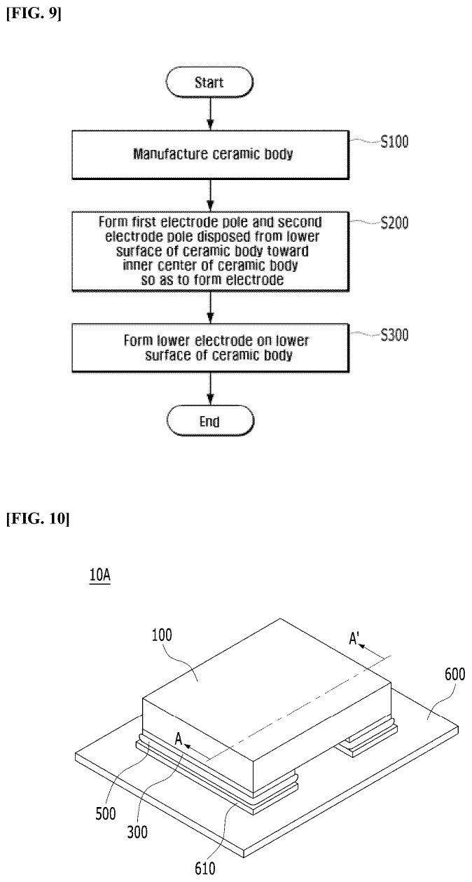

Meanwhile, FIG. 10 is a perspective view illustrating a state where a multilayer ceramic capacitor 10A according to another embodiment of the present disclosure is mounted on a circuit board 600.

Referring to FIG. 10, a multilayer ceramic capacitor 10A according to another embodiment of the present disclosure includes a ceramic body 100 and a lower electrode 300.

The ceramic body 100 is constituted by stacking a plurality of dielectric layers. The dielectric layer includes a material capable of obtaining capacitance. For example, the dielectric material may include a ceramic powder, ceramic additives, and the like. The dielectric layer may also be composed of a ceramic green sheet, and the thickness of the dielectric layer may be arbitrarily changed to fit to the capacity design according to an embodiment of the present disclosure.

There are no particular restrictions on the shape of the ceramic body 100, but, as illustrated, the ceramic body 100 may be formed in a hexahedron shape. Although corners of the ceramic body 100 are not perfectly straight due to high temperature and the like in a manufacturing process, the ceramic body 100 may have substantially the hexahedron shape.

The lower electrode 300 is formed on a lower surface of the ceramic body 100. There are no particular restrictions on the material that forms the lower electrode 300, and the lower electrode 300 may be formed by using a conductive material including, for example, silver, copper, lead, platinum, and nickel.

Further, although not illustrated, the lower electrode 300 may be formed in a three-layer structure of copper, silver-epoxy, and nickel. Tin may be used instead of nickel. In this case, the silver-epoxy may absorb an external force that is applied to the lower electrode 300, and may prevent cracks from occurring on the ceramic body 100.

If a voltage is applied to the lower electrode 300, electric charge is accumulated on inner electrodes to be described later. The details thereof will be described later.

The lower electrode 300 may be seated on a circuit pattern 610 of the circuit board 600, and may be joined to a solder 500. A process of joining the lower electrode 300 to the circuit pattern 610 is called soldering.

Although not illustrated, the solder 500 may rise up an outer side surface of the lower electrode 300, or may partially cover an outer side surface of the ceramic body 100.

The solder 500 may be made of a material having prominent mechanical properties and electrical conductivity. For example, the solder 500 may be made of a tin-lead alloy and the like.

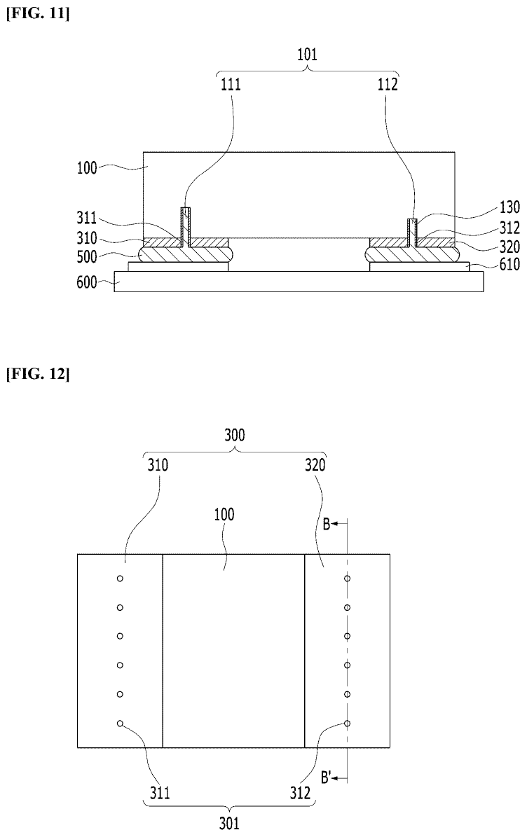

FIG. 11 is a cross-section view taken along line A-A′ of FIG. 10, and FIG. 12 is a bottom view of FIG. 10.

Referring to FIGS. 11 and 12, the lower electrode 300 is disposed on the lower surface of the ceramic body 100 as described above. The lower electrode 300 may be formed by printing or applying the lower electrode material on the lower surface of the ceramic body 100 produced by a dielectric material.

The lower electrode 300 includes a first lower electrode 310 and a second lower electrode 320.

The first lower electrode 310 and the second lower electrode 320 are formed on both sides of the lower surface of the ceramic body 100.

The lower electrode 300 includes through-holes 311 and 312 that are penetratingly formed in the height direction. The plurality of through-holes 311 and 312 may be provided. Further, corresponding to this, hollow grooves 111 and 112 are provided on the ceramic body 100.

The hollow grooves 111 and 112 are constitutions corresponding to hollow grooves (not illustrated) formed on the lower surface of the ceramic body 100 in order to form the electrode pole 200 in the above-described embodiment of FIG. 2.

In the embodiment of FIG. 11, the hollow grooves 111 and 112 are formed to be depressed on the lower surface of the ceramic body 100, and are formed at locations where outer peripheries of the hollow grooves 111 and 112 correspond to outer peripheries of the through-holes 311 and 312. That is, the through-holes 311 and 312 and the hollow grooves 111 and 112 communicate with each other. Accordingly, in a soldering process to be described later, the solder 500 may flow into the hollow grooves 111 and 112 through the through-holes 311 and 312.

In this case, the hollow grooves 111 and 112 are formed with a depression length (depth) that is equal to or larger than one-fifth and equal to or smaller than one-third of the height of the ceramic body 100. If the depression length of the hollow grooves 111 and 112 is equal to or larger than one-third of the height of the ceramic body 100, or the hollow grooves 111 and 112 are provided in the form of a hole that completely penetrates the ceramic body 100, cracks may occur on the ceramic body 100, and thus a problem may arise with durability.

As for the durability problem as above, the cracks can be prevented from occurring on the ceramic body 100 if the depression length of the hollow grooves 111 and 112 is limited to be equal to or larger than one-fifth and equal to or smaller than one-third of the height of the ceramic body 100.

In case of mounting the ceramic body 100 on the circuit board 600, the solder 500 is filled inside the hollow grooves 111 and 112 through the through-holes 311 and 312, and is electrically connected to the lower electrode 300 in the soldering process. Further, the solder 500 is also electrically connected to an inner electrode 200 to be described later.

In this case, a metal layer 130 may be formed on inner surfaces of the hollow grooves 111 and 112 and the through-holes 311 and 312 so that the solder 500 can be filled into the internal end of the hollow grooves 111 and 112. If the metal layer 130 as described above is formed, the melted solder 500 can flow smoothly into the inside end of the hollow grooves 111 and 112 due to the capillary phenomenon.

Further, in case that the solder 500 flows into the hollow grooves 111 and 112 through the through-holes 311 and 312, the joining force between the lower electrodes 310 and 320 and the ceramic body 100 is improved.

Further, as described above, a plurality of through-holes 311 and 312 may be provided. Specifically, the plurality of through-holes 311 and 312 may be provided at predetermined intervals along the length direction of the lower electrodes 310 and 320. Further, the plurality of hollow grooves 111 and 112 are disposed so as to communicate with the plurality of through-holes 311 and 312 disposed at predetermined intervals along the length direction of the lower electrodes 310 and 320.

Due to this, the solder 500 can flow into the plurality of through-holes 311 and 312 and hollow grooves 111 and 112, and thus the joining force between the first and second lower electrodes 310 and 320 and the ceramic body 100 can be further reinforced.

Meanwhile, the through-holes 311 and 312 include the first through-hole 311 and the second through-hole 312. The first through-hole 311 is formed on the first lower electrode 310, and the second through-hole 312 is formed on the second lower electrode 320.

The hollow grooves 111 and 112 include the first hollow groove 111 and the second hollow groove 112.

The first hollow groove 111 is formed at a location that corresponds to the first through-hole 311, that is, at a location that overlaps the first through-hole 311 in an upward or downward direction, so as to communicate with each other, and the second hollow groove 112 is formed at a location that corresponds to the second through-hole 312, that is, at a location that overlaps the second through-hole 312 in an upward or downward direction, so as to communicate with each other.

Meanwhile, among the metal layers 130 formed on the inner surfaces of the hollow grooves 111 and 112 and the through-holes 311 and 312, a part formed on the inner surfaces of the through-holes 311 and 312 is called a first metal layer, and a part formed on the inner surfaces of the hollow grooves 111 and 112 is called a second metal layer.

FIG. 13 is a cross-sectional view of an embodiment in which an inner electrode 200A is added to FIG. 11.

Referring to FIG. 13, the multilayer ceramic capacitor 10A may further include an inner electrode 200A.

The inner electrode 200A is disposed inside the ceramic body 100, and is electrically connected to the lower electrode 300 through a via.

The inner electrode 200A is composed of a conductive material that can store and discharge electric charge, and the material is not specially restricted. For example, the material may be composed of silver, lead, platinum, copper, or a combination thereof, but is not limited to the enumerated examples.

The inner electrode 200A includes a first inner electrode 210A and a second inner electrode 220A. The first inner electrode 210A and the second inner electrode 220A may be a pair of electrodes having different polarities, and a dielectric layer is disposed between the first inner electrode 210A and the second inner electrode 220A.

The first inner electrode 210A and the second inner electrode 220A are electrically connected to the first lower electrode 310 and the second lower electrode 320, respectively, through the metal layers 130 formed on the inner surfaces of the hollow grooves 111 and 112 and the through-holes 311 and 312 and the solder 500 that is filled inside the metal layers 130.

In this case, the first inner electrode 210A may be electrically connected through an end part of the first hollow groove 111, and the second inner electrode 220A may be electrically connected through an end part of the second hollow groove 112.

Meanwhile, in case of a general multilayer ceramic capacitor, the electric charge is charged on a pair of inner electrodes that are spaced apart from each other, and the first inner electrode 210A and the second inner electrode 220A of the multilayer ceramic capacitor 10A according to the illustrated embodiment should be disposed to be spaced apart from each other.

Accordingly, in the multilayer ceramic capacitor 10A according to the illustrated embodiment, the first hollow groove 111 and the second hollow groove 112 are formed with different depression lengths (depths). Due to this, the first inner electrode 210A and the second inner electrode 220A may be formed at different locations inside the ceramic body 100, and the first inner electrode 210A and the second inner electrode 220A may be constituted to be disposed spaced apart from each other.

In consideration of the locations of the first lower electrode 310 and the second lower electrode 320, the first inner electrode 210A is disposed to be biased toward one side surface of the inside of the ceramic body 100, and the second inner electrode 220A is disposed to be biased toward the other side surface of the inside of the ceramic body 100.

Accordingly, as shown in the illustrated embodiment, the first inner electrode 210A and the second inner electrode 220A form an overlap area where the first and second inner electrodes overlap each other in the center area of the ceramic body 100.

The overlap area where the first inner electrode 210A and the second inner electrode 220A vertically overlap each other may constitute an active area, and may perform a role of a capacitor (condenser).

The multilayer ceramic capacitor has both components of equivalent series resistance (ESR) and equivalent series inductance (ESL) in addition to the capacitance, and since the components of the equivalent series resistance and the equivalent series inductance are factors that impair the function of the capacitor, it is necessary to lower the values thereof.

This can be solved by shortening the length of a path in which electrons flow. Accordingly, it is preferable that the via is formed with a short length. Accordingly, as described above, the capacitor function can be improved by shortening the current path through forming of the hollow grooves 111 and 112 with the depression length that is equal to or larger than one-fifth and equal to or smaller than one-third of the height of the ceramic body 100.

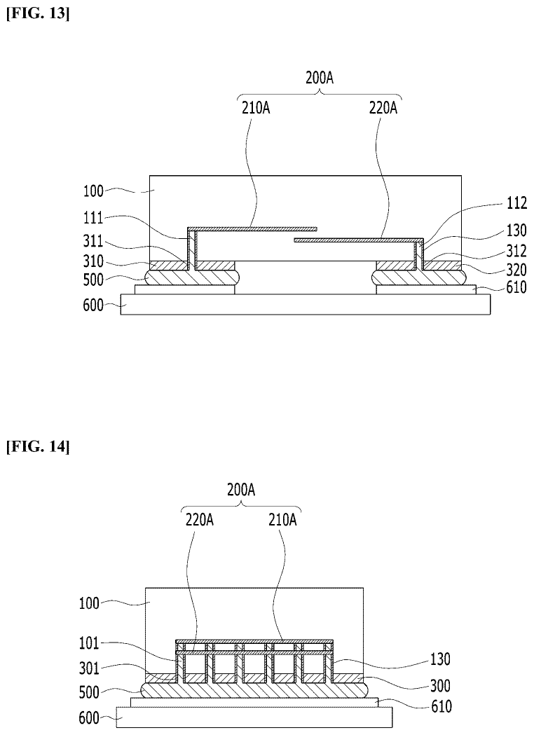

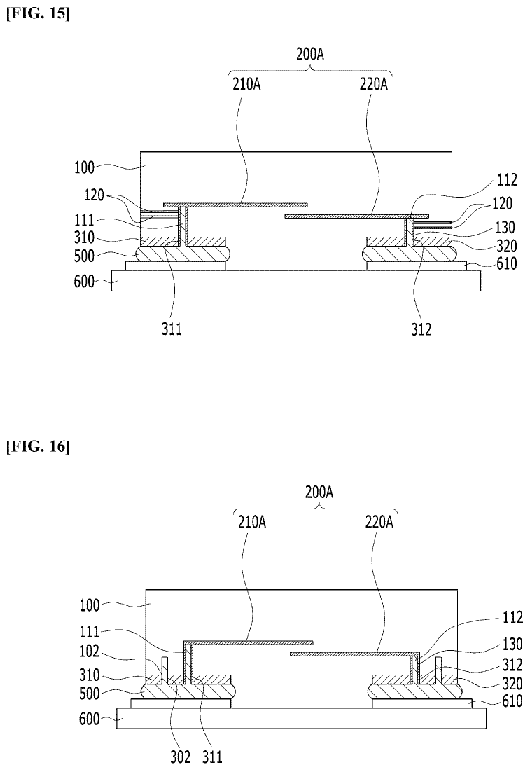

FIG. 14 is a cross-sectional view when FIG. 13 is viewed in the direction of B-B′ of FIG. 12.

Referring to FIG. 14, a plurality of hollow grooves 101 and through-holes 301 are disposed at predetermined intervals. The hollow groove 101 collectively calls a first hollow groove 111 and a second hollow groove 112, and the through-hole 301 collectively calls a first through-hole 311 and a second through-hole 312.

The through-hole 301 may be formed with a diameter that is equal to or larger than two-thirds of the thickness of the lower electrode 300 and equal to or smaller than the thickness of the lower electrode 300.

In the same manner, the hollow groove 101 may also be formed with a diameter that is equal to or larger than two-thirds of the thickness of the lower electrode 300 and equal to or smaller than the thickness of the lower electrode 300.

FIG. 15 is a cross-sectional view of another embodiment in which a discharge port is added to FIG. 13.

Referring to FIG. 15, discharge ports 120 are formed on both side surfaces of the ceramic body 100. Specifically, the discharge ports 130 may be formed to penetrate side surfaces of the ceramic body 100, being vertical to the hollow grooves 111 and 112, and to communicate with the hollow grooves 111 and 112.

The discharge port 120 forms a path for discharging air that is generated in a process in which the solder 500 that is melted in the soldering process flows into the hollow grooves 111 and 112 with its temperature being decreased.

In case that the discharge ports 120 are not provided, bubbles (empty spaces) may be formed in the solder 500 due to the air generated in the process in which the temperature of the melted solder 500 having flowed into the inside of the hollow grooves 111 and 112 is getting down. Due to this, the electrical conductivity of the capacitor may be reduced, and the rigidity of the capacitor may be weakened.

In the embodiment form of the present disclosure provided with the discharge ports 120, the above problem can be solved. In relation to the illustrated embodiment, the air that is generated inside the hollow grooves 111 and 112 as the temperature of the melted solder 500 in the soldering process is lowered may be discharged through the discharge ports 120. Due to this, the solder 500 can be disposed in a stick and cohered state without empty spaces inside the hollow grooves 111 and 112. Accordingly, the solder 500 that flows and is disposed inside the hollow grooves 111 and 112 has an excellent electrical conductivity and an improved rigidity, and thus the joining force between the lower electrode 300 and the ceramic body 100 can be improved.

As needed, a plurality of discharge ports 120 may be formed at predetermined intervals. Further, although not illustrated, the locations of the discharge ports 120 are not limited to the side surfaces of the ceramic body 100, and the discharge ports 120 may be connected to the hollow grooves 111 and 112, and may be penetratingly formed toward the outer surface of the ceramic body 100.

Further, in the illustrated embodiment, the first hollow groove 111 may be formed with a depression length (depth) that is longer than that as described above with reference to FIG. 11. Accordingly, the height of the end part of the first hollow groove 111 is set to be higher than the height with which the first inner electrode 210A is formed inside the ceramic body 100. Due to this, the first hollow groove 111 may be formed to penetrate the first inner electrode 210A. That is, the end part of the first hollow groove 111 may be at a location that is higher than the first inner electrode 210A inside the ceramic body 100.

In the same manner, in the illustrated embodiment, the second hollow groove 112 may be formed with a depression length that is longer than that as described above with reference to FIG. 11. Accordingly, the height of the end part of the second hollow groove 112 is set to be higher than the height with which the second inner electrode 220A is formed inside the ceramic body 100. Due to this, the second hollow groove 112 may be formed to penetrate the second inner electrode 220A. That is, the end part of the second hollow groove 112 may be at a location that is higher than the second inner electrode 220A inside the ceramic body 100.

As a result, the solder 500 having flowed into the hollow grooves 111 and 112 in the soldering process electrically connects the lower electrode 300 and the inner electrode 200A with each other stably.

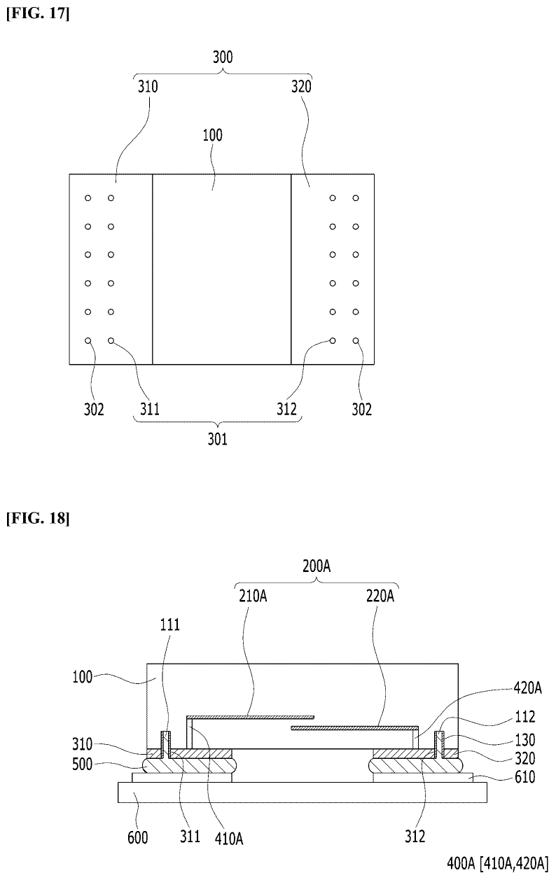

FIG. 16 illustrates another embodiment of FIG. 13, and FIG. 17 is a bottom view of FIG. 16.

Referring to FIGS. 16 and 17, the multilayer ceramic capacitor 10A according to another embodiment of the present disclosure may further include a joining hole 302 and a joining groove 102.

The joining hole 302 is penetratingly formed along the height direction of the lower electrode 300. In this case, the joining hole 302 is formed at a location that does not overlap the above-described through-holes 311 and 312.

The joining groove 102 is formed to be depressed on the lower surface of the ceramic body 100. The outer periphery of the joining groove 102 corresponds to the outer periphery of the joining hole 302, and is formed at the location that overlaps the joining hole 302 in an upward or downward direction. In this case, the joining groove 102 is formed at the location that does not overlap the hollow grooves 111 and 112.

As described above, the via is formed as the solder 500 is filled in the through-holes 311 and 312 and the hollow grooves 111 and 112 in the soldering process, and in this case, the solder 500 fills the joining groove 102 through the joining hole 302.

Due to this, the inner surface of the joining groove 102 and the solder 500 join each other. This means that the dielectric layer of the ceramic body 100 and the solder 500 join each other. This may give additional rigidity to the ceramic body 100.

That is, the lower electrode 300 is located between the solder 500 and the ceramic body 100, and thus the joining force between the lower electrode 300 and the ceramic body 100 can be reinforced.

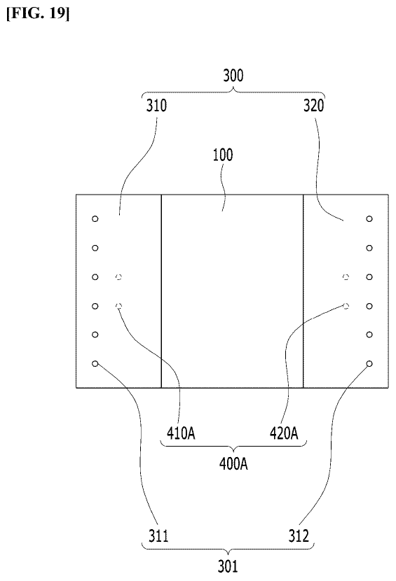

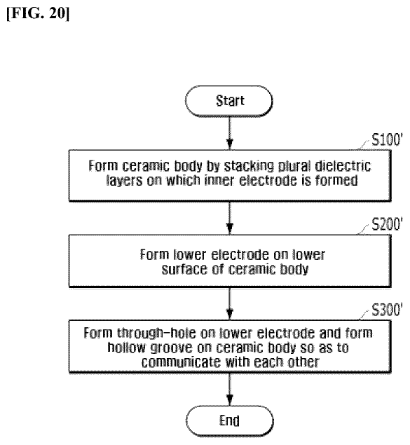

FIG. 18 is a cross-sectional view of another embodiment of FIG. 13, and FIG. 19 is a bottom view of FIG. 18.

Referring to FIGS. 18 and 19, unlike the above-described embodiments, the illustrated embodiment includes vias 410A and 420A disposed to be spaced apart from the hollow grooves 111 and 112 formed on the ceramic body 100.

The vias 410A and 420A electrically connect the lower electrodes 310 and 320 and the inner electrodes 210A and 220A with each other. Specifically, the first via 410A electrically connects the first lower electrode 310 and the first inner electrode 210A with each other, and the second via 420A electrically connects the second lower electrode 320 and the second inner electrode 220A with each other.

The vias 410A and 420A in the illustrated embodiment has a more stable current flow than that of the electrical connection structure of the lower electrodes 310 and 320 and the inner electrodes 210 and 220 through the hollow grooves 111 and 112 as described above in another embodiment.

Hereinafter, a method for manufacturing a multilayer ceramic capacitor according to an embodiment form of the present disclosure will be described, but the embodiment of the present disclosure is not limited thereto.

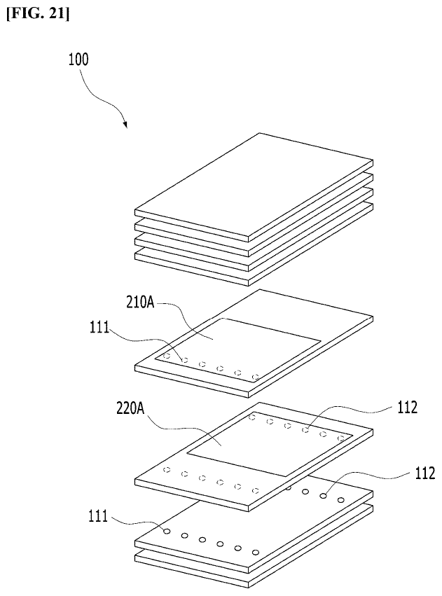

FIG. 20 is a flowchart illustrating a method for manufacturing a multilayer ceramic capacitor according to the present disclosure, and FIG. 21 is a perspective view illustrating a stacked state of a ceramic body in step S100′ of FIG. 20.

Referring to FIGS. 20 and 21, a method for manufacturing a multilayer ceramic capacitor according to the present disclosure includes: a step (S100′) of forming a ceramic body 100 by stacking a plurality of dielectric layers on which an inner electrode 200A is formed; a step (S200′) of forming a lower electrode 300 on a lower surface of the ceramic body 100; and a step (S300′) of forming through-holes 311 and 312 on the lower electrode 300 and forming hollow grooves 111 and 112 on the ceramic body 100 so as to communicate with each other.

First, in the step (S100′) of forming the ceramic body, the plurality of dielectric layers are stacked in the height direction of the ceramic body 100, and the stacked dielectric layers are compressed by heat. In this case, the inner electrode 200A may be formed by printing a pattern in advance between the plurality of dielectric layers.

In this case, the first inner electrode 210A and the second inner electrode 220A may be formed and disposed to be spaced apart from each other, and may be formed to face each other.

Next, in the step (S200′), the lower electrode 300 is formed on the lower surface of the ceramic body 100. The lower electrode may be formed in a three-layer structure by applying copper, silver-epoxy, and nickel in order on the lower surface of the ceramic body 100. In this case, tin may be used instead of nickel. At this time, heat treatment at a high temperature may be performed so that the lower electrode 300 reveals the electrical properties in the process of applying copper, silver-epoxy, and nickel.

In this case, the first lower electrode 310 and the second lower electrode 320 may be formed on both sides of the lower surface of the ceramic body 100, and since the detailed explanation of the first lower electrode 310 and the second lower electrode 320 is the same as that described above, the detailed explanation thereof will be omitted.

Next, in the step (S300′), the through-hole 301 is formed by radiating the laser onto the sintered lower electrode 300. In this case, a plurality of through-holes 301 may be formed at predetermined intervals along the length direction of the lower electrode 300.

Further, in the step (S300′), the hollow groove 101 is formed by radiating the laser more deeply onto the through-hole 301 formed on the lower electrode 300. In this case, in the same manner, the plurality of hollow grooves 101 are formed at predetermined intervals. The hollow groove 101 communicates with the through-hole 301. In this case, the hollow groove 101 is formed with the depression length (depth) that is equal to or larger than one-fifth and equal to or smaller than one-third of the height of the ceramic body 100.

Further, the first hollow groove 111 is formed on the first lower electrode 310, and the second hollow groove 112 is formed on the second lower electrode 320, and in this case, the first hollow groove 111 and the second hollow groove 112 are formed with different depression lengths.

Since the detailed explanation of the depression length or the diameter of the hollow groove 101 is the same as that of the embodiments of the multilayer ceramic capacitor 10A described above, the detailed explanation thereof will be omitted.

Meanwhile, the multilayer ceramic capacitor 10A of the present disclosure is mounted on the circuit board 600 through the soldering process. In this case, since the melted solder 500 flows into the through-hole 301 of the lower electrode 300, and then flows into the hollow groove 101 through the through-hole 301, the lower electrode 300 and the inner electrode 200A are electrically connected.

Meanwhile, according to another embodiment, the step (S200′) includes a step of forming, on the lower electrode, a joining hole 302 which is penetratingly formed in the height direction of the lower electrode 300 and which does not overlap the through-hole 301.

Further, the step (S200′) includes a step of forming a joining groove 102, which is formed to be depressed on the lower surface of the ceramic body 100 to correspond to the outer periphery of the joining hole 302 and which does not overlap the hollow groove 101.

Further, in another embodiment, in the step (S200′), the metal layer may be formed by sputtering the inner surface of the through-hole 301. Further, the metal layer may be formed by sputtering the inner surface of the hollow groove 101.

Since the ceramic body 100 is not made of a conductive material, the melted solder 500 can easily flow into the hollow groove 101 by the metal layer 130 formed on the inner surfaces of the through-hole 301 and the hollow groove 101.

Meanwhile, as described above, the metal layer 130 formed on the inner surface of the through-hole 301 of the lower electrode 300 is defined as the first metal layer. Since the lower electrode 300 may be formed in a two-layer or three-layer structure composed of various materials, other than a single-layer structure, the melted solder 500 can smoothly pass through the through-hole 301 due to the first metal layer.

The above explanation of the present disclosure is merely for exemplary explanation of the technical idea of the present disclosure, and it can be understood by those of ordinary skill in the art to which the present disclosure pertains that various corrections and modifications thereof will be possible in a range that does not deviate from the essential characteristics of the present disclosure. Accordingly, it should be understood that the embodiments disclosed in the present disclosure are not to limit the technical idea of the present disclosure, but to explain the same, and thus the scope of the technical idea of the present disclosure is not limited by such embodiments. The scope of the present disclosure should be interpreted by the appended claims to be described later, and all technical ideas in the equivalent range should be interpreted as being included in the scope of the present disclosure.

1. A multilayer ceramic capacitor comprising:
a ceramic body in which a plurality of dielectric layers are stacked;
a lower electrode formed on a lower surface of the ceramic body; and
a hollow groove formed to be depressed from the lower surface of the ceramic body toward an inside of the ceramic body.

2. The multilayer ceramic capacitor of claim 1, further comprising an electrode pole formed in the hollow groove,
wherein the electrode pole includes:
a first electrode pole formed on one side of the lower surface of the ceramic body; and
a second electrode pole formed on the other side of the lower surface of the ceramic body, and
wherein the first electrode pole and the second electrode pole form an electrode.

3. The multilayer ceramic capacitor of claim 2, wherein the lower electrode comprises a first lower electrode and a second lower electrode formed on both sides of the lower surface of the ceramic body, and
wherein the first electrode pole and the second electrode pole are formed to face each other at a location symmetrical to the lower surface of the ceramic body.

4. The multilayer ceramic capacitor of claim 2, wherein the electrode pole is formed so that a length direction thereof is in parallel to a height direction of the ceramic body, and
wherein a diameter of a cross section that is vertical to the length direction of the electrode pole is reduced toward an inner center of the ceramic body.

5. The multilayer ceramic capacitor of claim 3, wherein a plurality of first electrode poles are disposed along a length direction of the first lower electrode, and
wherein a plurality of second electrode poles are disposed along a length direction of the second lower electrode, and the second electrode poles maintain the same interval as the interval of the first electrode poles, respectively.

6. The multilayer ceramic capacitor of claim 2, wherein the electrode pole is provided with a metal layer on a surface thereof.

7. The multilayer ceramic capacitor of claim 2, wherein the electrode pole is formed with a length that is equal to or smaller than a half of a height of the ceramic body.

8. The multilayer ceramic capacitor of claim 1, comprising a plurality of inner electrodes disposed to face each other inside the ceramic body,
wherein the lower electrode includes a through-hole formed to penetrate the lower electrode in a height direction, and
wherein the ceramic body includes a hollow groove formed inside the ceramic body to communicate with the through-hole.

9. The multilayer ceramic capacitor of claim 8, wherein the lower electrode comprises a first lower electrode and a second lower electrode formed on both sides of the lower surface of the ceramic body, and
wherein the through-hole includes:
a first through-hole formed on the first lower electrode; and
a second through-hole formed on the second lower electrode, and
wherein the hollow groove includes:
a first hollow groove formed to correspond to the first through-hole; and
a second hollow groove formed to correspond to the second through-hole, and
wherein the first hollow groove and the second hollow groove have different lengths.

10. The multilayer ceramic capacitor of claim 9, wherein the inner electrode comprises:
a first inner electrode connected to the first hollow groove; and
a second inner electrode connected to the second hollow groove, and
wherein the first inner electrode is disposed to be biased toward one side surface of an inside of the ceramic body, and
wherein the second inner electrode is disposed to be biased toward the other side surface of the inside of the ceramic body.

11. The multilayer ceramic capacitor of claim 10, wherein the first inner electrode and the second inner electrode form an overlap area.

12. The multilayer ceramic capacitor of claim 8, wherein the through-hole is formed with a diameter that is equal to or larger than two-thirds of a thickness of the lower electrode and equal to or smaller than a thickness of the lower electrode.

13. The multilayer ceramic capacitor of claim 8, wherein the hollow groove is formed with a diameter that is equal to or larger than two-thirds of a thickness of the lower electrode and equal to or smaller than a thickness of the lower electrode.

14. The multilayer ceramic capacitor of claim 8, wherein a plurality of through-holes are disposed at predetermined intervals along a length direction of the lower electrode, and
wherein a plurality of hollow grooves are disposed to communicate with the through-holes.

15. The multilayer ceramic capacitor of claim 8, wherein the hollow groove is formed with a length that is equal to or larger than one-fifth and equal to or smaller than one-third of a height of the ceramic body.

16. The multilayer ceramic capacitor of claim 8, wherein a first metal layer is formed on an inner surface of the through-hole, and
wherein a second metal layer is formed on an inner surface of the hollow groove.

17. The multilayer ceramic capacitor of claim 8, wherein the lower electrode comprises a joining hole formed to penetrate the lower electrode in a height direction and not to overlap the through-hole, and
wherein the ceramic body includes a joining groove formed to be depressed on the lower surface of the ceramic body, to correspond to an outer periphery of the joining hole, and not to overlap the hollow groove.

18. The multilayer ceramic capacitor of claim 8, wherein the ceramic body comprises a discharge port formed to penetrate a side surface of the ceramic body and the hollow groove.

19. The multilayer ceramic capacitor of claim 8, wherein the ceramic body comprises a via disposed to be spaced apart from the hollow groove on the lower surface of the ceramic body and electrically connected to the lower electrode, and
wherein the via includes:
a first via electrically connected to a first lower electrode; and
a second via electrically connected to a second lower electrode.
